(19) United States
(12) Patent Application Publication
(10) Pub. No.: US 2013/0231794 A1
(43) Pub. Date: Sep. 5, 2013

(54) POWER MANAGEMENT SYSTEM WITH GRANULARIZED CONTROL AND INTELLIGENT POWER REDUCTION

(71) Applicant: VEEDIMS, LLC, Fort Lauderdale, FL (US)

(72) Inventors: JONATHAN S. FICK, Westford, VT (US); CLAUDIO R. BALLARD, Fort Lauderdale, FL (US); ANDREW P. SARGENT, Chittenden, VT (US)

(73) Assignee: VEEDIMS, LLC, Fort Lauderdale, FL (US)

(21) Appl. No.: 13/772,297

(22) Filed: Feb. 20, 2013

Related U.S. Application Data
(60) Provisional application No. 61/601,019, filed on Feb. 20, 2012.

(51) Int. Cl. G06F 1/26

(52) U.S. Cl. CPC G06F 1/26
USPC 700/295

(57) ABSTRACT

A power management system including granularized control and intelligent power reduction comprises a plurality of devices interconnected on a data/power network. A control node is connected on the data/power network in data communication with the plurality of devices and receiving signals indicative of the power requirements of the individual devices and detecting a total available power for the system. The system further comprises a respective operational priority value corresponding to each of the respective devices. The control node compares the total of the power requirements for all of the devices to the total available power for the system. When the total of the power requirements exceeds the total power available, the control node determines which of the devices has the lowest operational priority value and sends control signals to that device, causing it to either reduce its power use by an incremental amount or turn OFF.

### CROSS-REFERENCE TO RELATED APPLICATIONS

This application claims benefit of U.S. Provisional Application No. 61/601,019, filed Feb. 20, 2012, entitled POWER MANAGEMENT SYSTEM WITH INTELLIGENT POWER REDUCTION (Atty. Dkt. No. VLLC-31157), the specification of which is incorporated herein in its entirety.

### TECHNICAL FIELD

The following disclosure relates to systems and apparatus for the management of power use across a network of interconnected devices, and in particular to the management of power use by individual devices interconnected in a data/power network so as to manage the overall power requirements of the devices connected to the data/power network.

### BACKGROUND

It is known to connect multiple devices into a control system for supplying power and/or control signals. For example, a marine vessel may have a control system that requires more than seventy bulkhead valves be closed in an emergency situation. The valves may consist of fluid valves, air duct valves, fire dampers, and related functions that separate watertight compartments.

In the control system of some existing vessels, each of the seventy valves is served by a seven-conductor cable that requires a “home run” (i.e., direct connection) to a control panel in the pilot house. Certain conductors serve the motor and other conductors return open/close switch information to the control panel. Conductor size is dictated by ABS. Conductor size must accommodate surge current, run current, and short-circuit current. This implies a significant quantity of cabling, in bulk, weight, and cost. The valve motors are not individually controlled; they are instead all actuated by a single switch in the pilothouse.

A need therefore exists, for a granularized power management system wherein multiple devices are served by a single cable providing both power and control signals. A need further exists, for a granularized power management system wherein each device among multiple devices connected on a single cable may be individually controlled. A need still further exists, for a granularized power management system that controls the power use by individual devices interconnected in a network so as to manage the overall power requirements of the devices connected to the network.

In other cases, the power available on a system controlling and powering multiple devices may become insufficient to operate all of the devices connected to the system, or the power available on a particular cable of the system may become insufficient to operate all of the devices connected to that cable. In a conventional system, all of the devices on the system (or particular cable) may become inoperative due to the insufficient power, or alternatively one or more of the devices may become inoperative in an unpredictable manner (i.e., unpredictable as to which of the multiple devices will become and/or remain inoperative). A need therefore exists, for a power management system with intelligent power reduction that can advantageously manage the multiple devices on a system or cable when there is insufficient power to operate all of the devices on the system or cable.

### SUMMARY

In one aspect of the current invention, a granularized power management system comprises a power/data network and a control system whereby a single power/data cable provides power and control signals to a number of devices. In one embodiment thereof, the devices are valves.

In another aspect thereof, a granularized power management system includes native embedded data communications within the system to provide valve open/close status as well as ancillary data (e.g., motor current, temperature, etc.) on a per-valve basis. In embodiments thereof, the control system provides motor control and/or current fault protection to the valves. In a preferred embodiment thereof, the power management system includes a VEEDIMS® control and data/power system.

In another aspect thereof, a granularized power management system provides that each valve is individually controlled.

In another aspect thereof, a single VEEDIMS® power/data cable can serve a multiplicity of valves if emergency valve operation is sequenced, either by fully actuating one valve at a time until all valves are actuated, or by partially actuating each valve in a sequence and looping until all are fully actuated. In one variation of the aspect above, the total current requirement, hence cable size, is limited due to a single or small number of valves being simultaneously actuated. In another variation of the aspect above, the total cable content in the system is limited because a single cable will successfully serve a multiplicity of valves.

In another aspect thereof, a granularized power management system provides that relevant agency-required operational data is available for each valve because each valve is individually addressable.

In another aspect thereof, a granularized power management system provides that data of an analog nature (e.g., percentage closed, motor current, temperature, etc.) may be returned to the controlling system because a VEEDIMS® control and data/power system acquires all types of data, converts the data to VEEDIMS® protocol, and returns that data via Ethernet.

In another aspect thereof, a granularized power management system provides that continuous and/or periodic system health may be ascertained because valves may be exercised on an individual basis; i.e., partially or fully closed as needed so as to be transparent or semi-transparent to the functional operation of the system in which the VEEDIMS® control and data/power system resides.

In another aspect thereof, a granularized power management system comprises design software, wherein a VEEDIMS® control and data/power system may be optimized so that a project can be specified and designed. Once the VEEDIMS® control and data/power system is installed, the VEEDIMS® control and data/power system allows for automatic discovery and mapping which provides the means to dynamically optimize the system, including dynamic recommendations for valve sequencing.

In another aspect thereof, a power management system including intelligent power reduction comprises a plurality of devices interconnected on a data/power network. A control node is operatively connected on the data/power network in data communication with the plurality of devices and receiving signals indicative of the power requirements of the individual devices in the plurality of devices and detecting a total available power for the system. The system further comprises a respective operational priority value corresponding to each of the respective devices. The control node compares the total of the power requirements for all of the devices to the total available power for the system, and when the total of the power requirements exceeds the total power available, the control node determines which of the devices has the lowest operational priority value and sends control signals to that device causing that device to either reduce its power use by an incremental amount or turn OFF.

In another aspect thereof, a power management system including intelligent power reduction further comprises intelligent power restoration that occurs after intelligent power reduction.

### BRIEF DESCRIPTION OF THE DRAWINGS

For a more complete understanding, reference is now made to the following description taken in conjunction with the accompanying Drawings in which:

FIG. 1 shows a functional block diagram of a power management system with granular control in accordance with aspects of the invention;

FIG. 2 shows a functional block diagram of another power management system with granular control in accordance with aspects of the invention; and

FIG. 3 shows a functional block diagram of a power management system with intelligent power reduction and/or intelligent power restoration in accordance with additional aspects of the invention.

### DETAILED DESCRIPTION

In traditional power design and conductor sizing, some of the primary factors in design are the voltage, load current characteristics, and thermal rise. Beyond a simple resistive circuit, the design must include sufficient capacity for inrush current due to inductance and other effects, as well as conservative margins for reliability and safety.

As an example, a motor might draw 5 amps while running under load but require 20 amps for a short time until the rotor spins up to speed. Although the inrush current is short in duration it is nonetheless real, and if cabling lacks sufficient ampacity (i.e., capacity for current) the voltage delivered to the motor will be reduced which will keep the motor in “startup” mode for a longer period of time, thus at a higher current. In a system of five such motors, cable sizing would need to accommodate a 25 amp load while motors are running and 100 amps while starting, and would carry commensurate cost, weight, and natural resources such as copper, oil, etc. This assumes that there is nothing in the system to prevent all the motors from starting simultaneously.

U.S. Pat. No. 7,940,673 to Ballard et al. entitled “System For Integrating A Plurality Of Modules Using A Power/Data Backbone Network” discloses a Virtual Electrical and Electronic Device Interface and Management System (known as VEEDIMS; now a trademark of Veedims, LLC). Such a VEEDIMS® system can be adapted to act as a power management system with granular control in accordance with aspects of the invention.

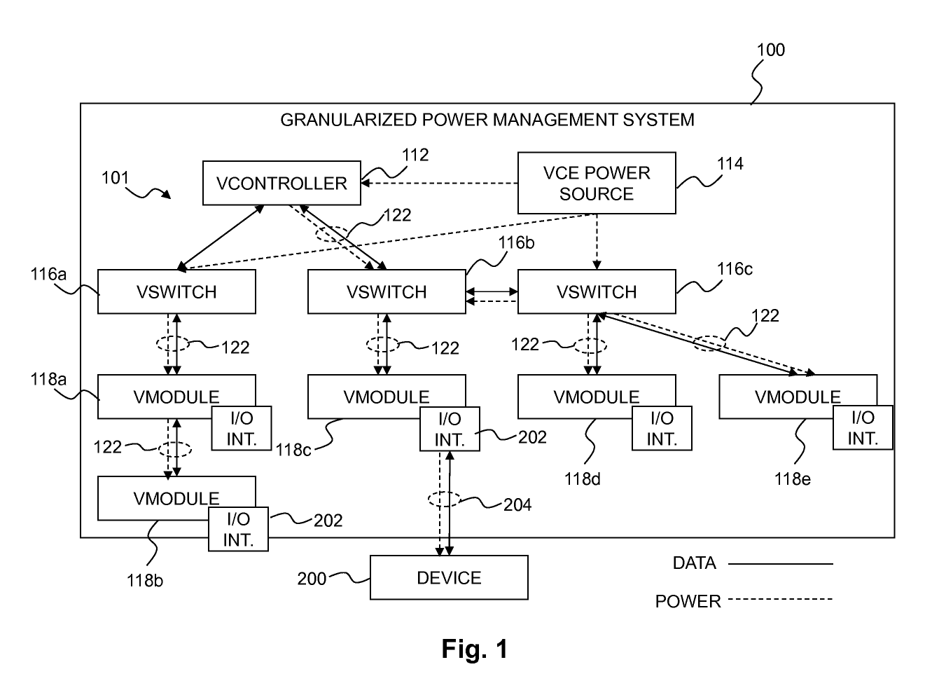

Referring now to FIG. 1, there is illustrated one embodiment of a power management system with granular control utilizing a VEEDIMS® system. The granularized power management system 100 includes a backbone network 101 formed by cables 122 that are configured to simultaneously carry digital data and power. A controller 112 (in this case, a VEEDIMS® “VCONTROLLER”) is coupled to the backbone network 101 and configured to execute control instructions. A plurality of modules 118 (in this case, VEEDIMS® “VMODULES” 118a-118e) are coupled to the controller 112 via the backbone network 101 and receive data and power via the backbone network. The modules 118 receive control signals from the controller 112 based on the control instructions. A power source 114 may be provided to supply power to the controller 112, modules 118 and/or to the other networked devices.

Referring still to FIG. 1, at least one device 200 is coupled to one of the modules 118 (in this case, module 118c) via an input/output (I/O) interface 202 positioned in the module and a cable 204. The cable 204 illustrated in FIG. 1 carries both power and data to/from the device 200, however, in other embodiments the cable may carry only power or only data to/from the device 200. The cable 204 may be a discrete cable or it may be a functional connection within a single unit, for example where the module 118c and device 200 are configured in a single enclosure. A device-specific driver contained in the module 118 provides a communications interface between the device 200 and a generic VEEDIMS® controller driver in the controller 112. A granularized power management system according to some embodiments of the current invention may comprise such a VEEDIMS® system. It will be appreciated, however, that use of a VEEDIMS® system is not required; a granularized power management system according to other embodiments may comprise other types of control and/or network designs.

U.S. Pat. No. 7,740,501 to Ballard et al. entitled “Hybrid Cable For Conveying Data And Power” and U.S. Patent Application Publication No. 2010/0319956 to Ballard et al. entitled “Hybrid Cable For Conveying Data And Power” disclose hybrid cables for conveying data and conducting operating power to electrically powered devices and a vehicle utilizing such cables. A granularized power management system according to the current invention may comprise one or more of such hybrid cables. It will be appreciated, however, that use of such hybrid cables are not required. Thus, a granularized power management system according to other embodiments may include other types of cables, including separate data-conveying cables and power-conveying cables.

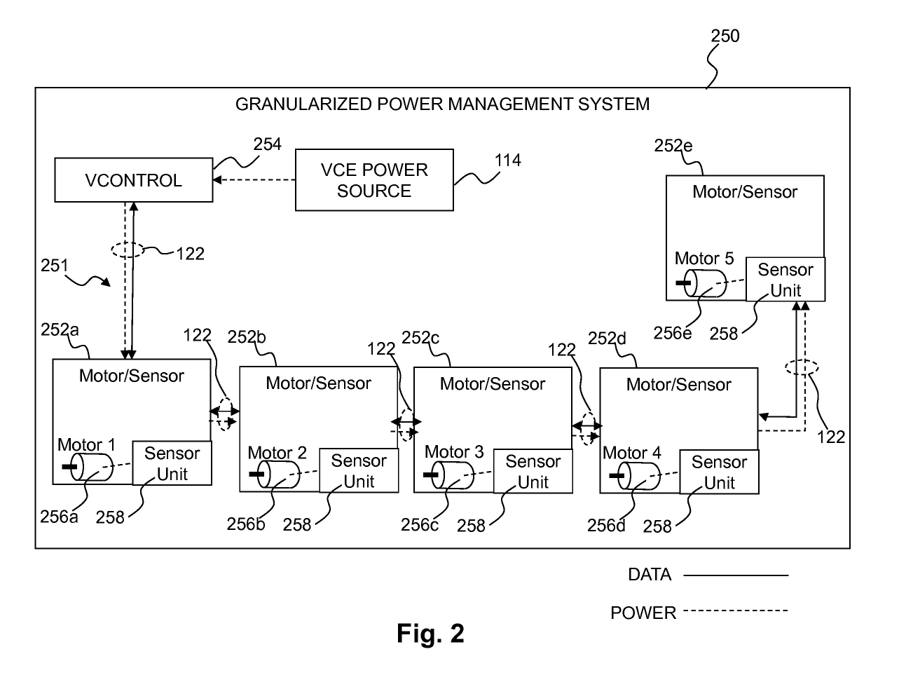

Referring now to FIG. 2, a granularized power management system 250 according to another embodiment includes a VEEDIMS® control and data/power system 251 and a plurality of “VEEDIMized” (i.e., adapted to operate on the VEEDIMS® system) motors/sensors 252 plus a control node 254 (known as a VEEDIMS® “Vcontrol”). In the example embodiment, five VEEDIMized motor/sensors 252a-252e are included. Each motor/sensor 252 includes a motor 256 and a sensor unit 258 operatively connected to each respective motor. The Vcontrol 254 includes the embedded intelligence to actuate one or more of the motors 256 in a sequence that is designed (prior to installation) and dynamically optimized (after installation) to minimize the average and peak current draw and thereby minimize cable 122 requirements (e.g., the size and/or capacity of the cable conductors). In short, all motors 256a-256e need not be actuated simultaneously; instead they may be sequentially activated. At any time, only one motor 256 (or a fraction of the total number of motors 256) would be active. Depending on the circumstances (e.g., alarm, flooding, fire, etc.), certain motors 256 could be activated on a priority basis. It will be appreciated that while this example embodiment describes control of multiple motors 256, in other embodiments devices such as sensors, valves, solenoids, relays, actuators, heaters, chargers and/or other devices may be controlled along with or instead of motors.

Referring still to FIG. 2, in one example embodiment, a granularized power management system 250 includes a Vcontrol control node 254 connected by a single data/power cable 122 to five motors 256, each motor drawing 5 amps while running under load but requiring 20 amps for startup. In the illustrated embodiment, the single cable 122 is “daisy chained” between the controlled devices 252a-252e, however in other embodiments, the single cable may be connected to the controlled devices in a different configuration. The system 250 may, upon receiving a “START ALL MOTORS” command, sequence the startup of the five motors 256a-256e as follows:

| Action | Current Requirement |
|---|---|
| a) Start Motor 1 (256a) | total current = 20 A; |
| b) Allow Motor 1 to come to running speed | total current = 5 A; |
| c) Start Motor 2 (256b), keeping Motor | total current = 25 A; |
| 1 running | |
| d) Allow Motor 2 to come to running speed, | total current = 10 A; |
| keeping Motor 1 running | |
| e) Start Motor 3 (256c), keeping Motors | total current = 30 A; |
| 1, 2 running | |
| f) Allow Motor 3 to come to running speed, | total current = 15 A; |
| keeping Motors 1, 2 running | |
| g) Start Motor 4 (256d), keeping Motors | total current = 35 A; |
| 1-3 running | |
| h) Allow Motor 4 to come to running speed, | total current = 20 A; |
| keeping Motors 1-3 running | |
| i) Start Motor 5 (256e), keeping Motors | total current = 40 A; |
| 1-4 running | |
| j) Allow Motor 5 to come to running speed, | total current = 25 A. |
| keeping Motors 1-4 running | |

It will be appreciated that in the example above controlled by the granularized power management system 250, starting all five motors 256a-256e requires a maximum current requirement of 40 amps, whereas in the earlier example (without the power management system), the maximum current requirement was 100 amps. The Vcontrol control node 254 is connected to each motor 256 by the system's data/power cable 122 such that data communications are possible. Thus, the Vcontrol control node 254 may provide sequential “START” control signals to each motor 256a-256e in turn, and monitor the power use of each motor and/or of the entire system 250 to determine whether each motor has come to running speed or is still starting.

In other embodiments, different control and/or sequencing patterns may be used to provide different results.

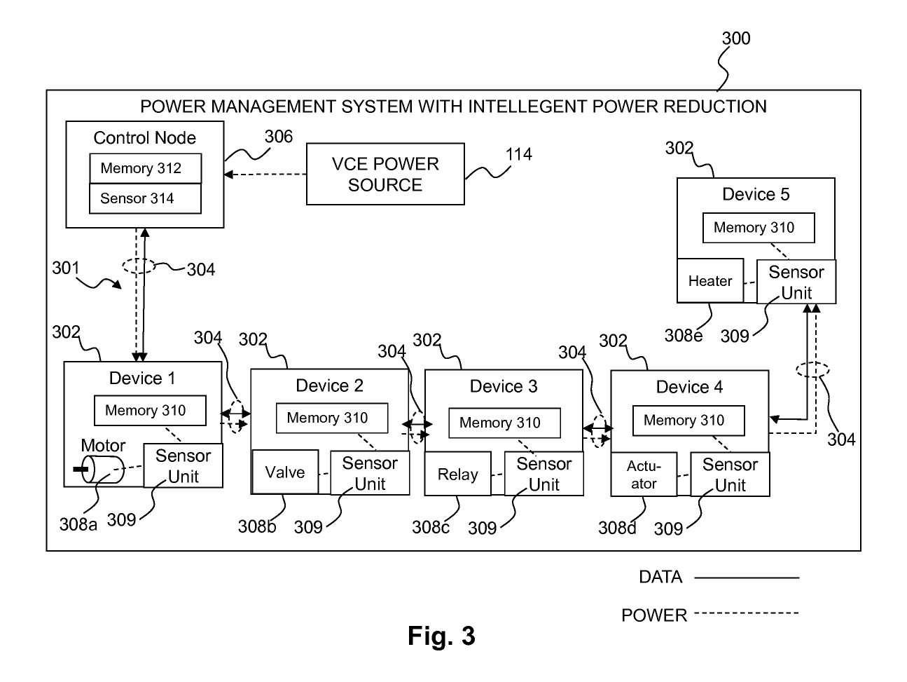

Referring now to FIG. 3, in another embodiment, a power management system with intelligent power reduction 300 is provided including a data/power system 301 having a plurality of controlled devices 302 , at least one hybrid cable 304 and at least one control node 306. The hybrid cable 304 carries both electrical power and data including control signals. The electrical power carried by the hybrid cable 304 may be alternating current (AC) and/or direct current (DC), and may include multiple current forms and voltages on a single cable. The control signals included in the data carried by the hybrid cable 304 may be analog signals and/or digital signals, and they may be carried on dedicated data/control conductors and/or on the power conductors of the cable. The control signals carried by the hybrid cable 304 are not limited to electrical signals, but may also include optical (i.e., light) signals carried on fiber optics or other signals carried by conductors of a type compatible with the signal type. The control signals may have a stand-alone character or be embedded in data carried on the cable. In some embodiments, the control signals may be carried by a network data communication protocol including, but not limited to, Ethernet type data communication.

Referring still to FIG. 3, the controlled devices 302 on the power management system 300 with intelligent power reduction may include, but are not limited to, one or more motors 308a, sensors 309, valves 308b, solenoids, relays 308c, actuators 308d, heaters 308e, chargers and other devices. Each of the controlled devices 302 has the ability to communicate data over the connected hybrid cable 304 and receive electrical power over the hybrid cable. Each of the controlled devices 302 further has a respective operational power requirement. In some embodiments, the operational power requirement for a particular controlled device may be predetermined and stored in a memory 310 on the controlled device 302. In other embodiments, the controlled device 302 may have the ability to determine its own operational power requirement, e.g., by detecting its own instantaneous power usage (e.g., with sensor 309) and/or its history of power usage over time, and storing the determined operational power requirement in a memory 310.

The control node 306 on the power management system with intelligent power reduction 300 has the ability to communicate with two or more of the controlled devices 302 connected to a particular system 301 or particular hybrid cable 304. The control node 306 obtains the operational power requirement for all of the controlled devices 302 connected on a particular system or cable 304. In some embodiments, the operational power requirements are loaded on the control node 306 by a system administrator. Such requirements may be stored in a control node memory 312. In other embodiments, the control node 306 may automatically determine the respective operational power requirement of each respective controlled device 302 by communicating with the device to obtain stored operational power information (e.g., from sensor unit 309 or memory 310).

The control node 306 further has the ability to detect the total power usage on the system 301 and/or on a particular hybrid cable 304. This power detection ability of the control node 306 may be direct, e.g., by using one or more control node sensors 314 directly sensing the current and/or voltage at one or more points on the system or cable, and/or indirect, e.g., by data communication with the controlled devices 302 where the controlled devices themselves have the ability to sense (e.g., with sensors 309) and report (i.e., communicate) power use.

The control node 306 still further has information regarding a respective operational priority value assigned to each respective controlled device 302 on a system 301 and/or a particular cable 304. In some embodiments, this operational priority information may be loaded on the control node by a system administration and stored in on-board memory 312. In other embodiments, this operational priority information may be stored on the controlled devices 302 (e.g., in device memories 310) and communicated to the control node 306 via data over the cable 304. The operational priority information for each controlled device 302 may be absolute (i.e., the operational priority value is fixed regardless of circumstances) or it may be conditional (i.e., the operational priority value may change depending on the circumstances on the system; e.g., a first operational priority value for startup operations, a second operational priority value for normal operation, a third operational priority value for emergency operation, etc.).

In one embodiment, the control node 306 of the power management system with intelligent power reduction 300 detects the total of the operational requirements for all of the controlled devices 302 on the system 301 (or on a particular cable 304), and compares that total to the total power availability for the system (or cable). If the power availability is below the total of the operational requirement (i.e., if the available power is insufficient to supply all of the devices 302 at current operational levels) then the control node 306 determines which of the controlled devices has the lowest operational priority (under the current circumstances). The control node 306 then communicates with the lowest operational priority controlled device 302 to direct that device to reduce its power consumption by a specified increment and/or to turn OFF completely. The control node 306 then repeats the process by detecting the new operational requirements for the remaining controlled devices 302 on the system (or cable) at their new power levels and comparing that total to the total power availability. If the power availability remains below the new operational requirement total, then the control node 306 again determines which of the controlled devices 302 has the lowest operational priority under the current circumstances. The control node 306 then communicates with the lowest operational priority controlled device 302 to direct that device to reduce its power consumption by a specified increment and/or to turn OFF completely. These steps are repeated until the total of the operational power requirements is less than or equal to the power availability.

In another embodiment, the control node 306 of the power management system 300 may further include intelligent power restoration. The system is similar to that described for the power management system with intelligent power reduction, however, each controlled device is further assigned a restoration priority value. In some embodiments, this restoration priority information may be loaded on the control node 306 by a system administration and stored in on-board memory 312. In other embodiments, this restoration priority information may be stored on the controlled devices 302 (e.g., in device memories 310) and communicated to the control node 306 via data over the cable 304. As with the operational priority values, the restoration priority value for each controlled device may be absolute or it may be conditional. However, it is not required that the restoration priority value for a device (or for particular circumstances) be of the same type or in any other way be related to the operational priority value.

Intelligent power restoration may occur after controlled devices 302 have been turned OFF or set to a lower power setting by intelligent power reduction due to a reduction in power availability. The control node 306 of the power management system with intelligent power restoration 300 detects the total of the operational requirements for all of the controlled devices 302 on the system 301 (or connected on a particular cable 304) and compares that total to the total power availability for the system (or cable). If the power availability is greater than the total of the operational requirement (i.e., if the available power is more than sufficient to supply all of the devices at current operational levels) then the control node 306 determines which of the controlled devices 302 has the highest restoration priority (under the current circumstances). The control node 306 then communicates with the highest restoration priority controlled device 302 to direct that device to increase its power consumption by a specified increment and/or to turn ON. In cases where turning ON a device may involve a higher-than-normal starting power requirement, the control node 306 or restoration priority value may include such information about starting so that the control node will wait until the available power is sufficiently above the current operational requirements to start the next device without causing another insufficient power situation to occur. The control node 306 then repeats the process by detecting the new operational requirements for the remaining controlled devices 302 on the system 301 (or cable 304) at their new power levels and comparing that total to the total power availability. If the available power level is still higher than the total of the current operational powers, then the control node 306 will again determine which of the controlled devices has the highest restoration priority, and then communicate with the highest restoration priority controlled device 302 to direct that device to increase its power consumption by a specified increment and/or to turn ON until all of the controlled devices are working at full power. It will be appreciated that both intelligent power reduction and intelligent power restoration may operate sequentially in a complementary way while the system is operating.

Although the preferred embodiment has been described in detail, it should be understood that various changes, substitutions and alterations can be made therein without departing from the spirit and scope of the invention as defined by the appended claims.

It will be appreciated by those skilled in the art having the benefit of this disclosure that this power management system provides granularized control and/or intelligent power reduction. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A granularized power management system for the management of power use across a network of interconnected devices, the system comprising:
a plurality of devices interconnected on a data/power network;
a control node operatively connected on the data/power network, in data communication with the plurality of devices and receiving signals indicative of the power use of the individual devices in the plurality of devices; and
wherein the control node sends control signals to the individual devices in the plurality of devices so as to control the power use of each individual device and of the plurality of devices, collectively, in accordance with a predetermined overall power allowance for the plurality of devices connected to the data/power network.

2. A power management system in accordance with claim 1, wherein the devices may be selected from a group including motors, sensors, valves, solenoids, relays, actuators, heaters, chargers.

3. A power management system in accordance with claim 1, wherein the data/power network is a VEEDIMS® network.

4. A granularized power management system as described herein.

5. A power management system including intelligent power reduction, the system comprising:
a plurality of devices interconnected on a data/power network;
a control node operatively connected on the data/power network, in data communication with the plurality of devices and receiving signals indicative of the power requirements of the individual devices in the plurality of devices and detecting a total available power for the system;
a respective operational priority value corresponding to each of the respective devices; and
wherein the control node compares the total of the power requirements for all of the devices to the total available power for the system, and when the total of the power requirements exceeds the total power available, the control node determines which of the devices has the lowest operational priority value and sends control signals to that device causing that device to either reduce its power use by an incremental amount or turn OFF.

6. A power management system in accordance with claim 5, further comprising intelligent power restoration as described herein.

7. (canceled)

8. (canceled)
